(19) United States
(12) Patent Application Publication
(10) Pub. No.: US 2024/0153334 A1
(43) Pub. Date: May 9, 2024

(54) METHODS, SYSTEMS, AND DEVICES FOR REUSE PRODUCTS, FOR REUSING PRODUCTS, AND PRODUCT REUSE PROMOTION

(71) Applicant: GLOBELET CORPORATION, Lewes, DE (US)

(72) Inventor: Ryan EVERTON, Lewes, DE (US)

(21) Appl. No.: 18/280,462

(22) PCT Filed: Mar. 7, 2022
(86) PCT No.: PCT/US2022/019191

§ 371 Date: Sep. 5, 2023

Related U.S. Application Data
(60) Provisional application No. 63/157,604, filed on Mar. 5, 2021.

(51) Int. Cl. G07F 7/06; A47G 19/22; A47L 15/00; G06Q 30/0208

(52) U.S. Cl. CPC G07F 7/0609; A47G 19/2227; A47L 15/0065; G06Q 30/0208

(57) ABSTRACT

Embodiments of the disclosure are directed to, among other things, methods, systems, apparatuses, and devices that are or configured for reuse, and promotion of reuse. While embodiments of the present disclosure are directed to devices, apparatus, systems and methods for reuse of cups (or other product which can be reused), at least some of the embodiments can be used for recycling products (which may be reused, or, materials thereof used to produce new products).

### RELATED APPLICATION

The subject application claims priority to and benefit of U.S. provisional patent application No. 63/157,604, filed Mar. 5, 2021, the entire disclosure of which is incorporated herein by reference in its entirety.

### FIELD OF THE DISCLOSURE

Embodiments of the disclosure are directed to, among other things, methods, systems, apparatuses, and devices that are or configured for enabling the reuse of products (e.g., drinking containers), and promotion of such reuse. While embodiments of the present disclosure are directed to devices, apparatus, systems and methods for reuse of cups (or other products which can be reused), at least some of the embodiments can be used for recycling products (which may be reused, or, materials thereof used to produce new products).

### BACKGROUND

One of the pressing issues of modern day life is dealing with the waste created at large social events, in particular, beverage container waste. While currently many venues have established recycling of beverage containers, many of the containers still end up being disposed of.

Embodiments of the present disclosure, present systems, methods and devices for addressing such waste, by reusing beverage containers (which may also be food containers) eliminating the requirement of recycling and disposal.

### SUMMARY OF THE EMBODIMENTS

In some embodiments, a stackable array of drinking cups is provided which includes a plurality of cups. Each cup includes a size and a shape configured for a nested, stacked arrangement with one-another, wherein each cup includes a near-field-communication/chip (NFC) device positioned within and/or on a portion of each cup.

Such embodiments can include one and/or another of (and in some embodiments, a plurality of, and in some embodiments, if not mutually exclusive: a majority of, substantially all of, or all of) the following structure, feature, function, step, or clarification, yielding yet further embodiments:
the NFC device is affixed to a bottom surface of each cup;
each cup includes a respective and specific height, different from the remainder of the plurality of cups;
each cup includes a bottom portion which includes a shape configured to shed water;
at least a portion of the bottom shape comprises at least one of a concave and convex surface configured to shed water;
a bottom interior surface portion of each cup includes at least one and preferably a plurality of equally spaced raised portions;
the NFC device is at least one and any of:
   water resistant;
   clear or with printable back;
   encoded uniquely to each cup;
   is readable via a mobile device;
   includes a QR code printed thereon; and
   an alphanumeric short-code printed thereon;
and
each cup includes a stamped or printed ID number.

In some embodiments, a drinking cup is provided which includes a near-field-communication/chip (NFC) device at least one of within and on a portion of each cup.

Such embodiments can include one and/or another of (and in some embodiments, a plurality of, and in some embodiments, if not mutually exclusive: a majority of, substantially all of, or all of) the following structure, feature, function, step, or clarification, yielding yet further embodiments:
the NFC device is adhered to a bottom surface of the cup;
the cup includes a bottom portion having a shape configured to shed water;
at least a portion of the bottom shape comprises at least one of a convex and concave surface configured to shed water;
the cup includes a size and shape configured for a stacked arrangement with one or more additional cups of different volumes;
a bottom interior surface portion of each cup includes a plurality of equally spaced raised portions;
the NFC device is at least one and any of:
   water resistant;
   clear or with printable back;
   encoded uniquely to each cup;
   is readable via a mobile device;
   includes a QR code printed thereon; and
   an alphanumeric short-code printed thereon;
and
each cup includes a stamped or printed ID number.

In some embodiments, a drinking cup receptacle bin, which includes a housing including a top end, bottom end, a side, and an interior, wherein the top end includes a door covering a corresponding opening for receiving at least one cup at a time.

Such embodiments can include one and/or another of (and in some embodiments, a plurality of, and in some embodiments, if not mutually exclusive: a majority of, substantially all of, or all of) the following structure, feature, function, step, or clarification, yielding yet further embodiments:
an arrangement tray located within the interior,
at least one removable container arranged beneath at least a portion of the arrangement tray,
   the at least one removable container optionally including at least one of a removable cover and carrying straps,
a visual indicator,
a stacking apparatus configured to place the at least one cup within a location on the arrangement tray upon being received via the opening, and
a wireless receiver configured to sense the at least one cup via near-field communication/chip (NFC) upon the at least one cup being positioned in proximity to the bin.

The visual indicator can be configured to at least one of: indicate the location of the opening for receiving the at least one cup, and indicate an amount of interior space remaining to receive cups. Additionally, the wireless receiver can be arranged on or within the door, such that, upon the at least one cup being placed on the door, the door opens allowing the at least one cup to be received within the interior.

The stacking apparatus can comprise a 2-axis mechanism for moving the at least one cup received into a respective location of the arrangement tray.

The at least one removable container can include an internal structure allowing for a stacked arrangement of cups received by the bin, and at least one of the top end, the bottom end, and the side are configured for opening to remove the received at least one cup.

In some embodiments, a drinking cup receptacle bin is provided which includes a housing including a top end, bottom end, a side, and an interior, wherein the top end includes a door covering a corresponding opening for receiving at least one cup, at least one removable container arranged beneath at least a portion of the arrangement tray, a visual indicator, and a wireless receiver configured to sense the at least one cup via near field communications/chip (NFC) upon the at least one cup being positioned in proximity to the bin. The visual indicator can be configured to at least one of: indicate the location of the opening for receiving the at least one cup; and indicate an amount of interior space remaining to receive cups. The wireless receiver is arranged on or within the door, such that, upon the at least one cup being placed on the door, the door opens allowing the at least one cup to be received within the interior. At least one of the top end, the bottom end, and the side are configured for opening to remove the received at least one cup.

Such embodiments can include one and/or another of (and in some embodiments, a plurality of, and in some embodiments, if not mutually exclusive: a majority of, substantially all of, or all of) the following structure, feature, function, step, or clarification, yielding yet further embodiments:
an arrangement tray located within the interior, and
a stacking apparatus configured to place the at least one cup within a location on the arrangement tray upon being received via the opening.

The at least one removable container optionally includes at least one of a removable cover and carrying straps, where the at least one container includes carrying straps.

The stacking apparatus can comprise a 2-axis mechanism for moving the at least one cup received into a respective location of the arrangement tray, the at least one removeable container includes an internal structure allowing for a stacked arrangement of cups received by the bin, the NFC for the at least one cup is read prior to cleaning, and upon completion of cleaning, the cup and associated NFC is designated clean and data associated with the user for a respective cup is then scrubbed, the stacking apparatus comprises a 2-axis mechanism for moving the at least one cup received into a respective location of the arrangement tray; and/or the at least one removable container includes an internal structure allowing for a stacked arrangement of cups received by the bin.

In some embodiments, a portable drinking cup reuse system is provided, which includes a portable housing having a size and shape to accommodate at least one person, the housing include a first end and a second end and configured for automotive/truck transport, at least one door included on at least one of the first end and the second end, the first end is configured to receive used cups for cleaning and reuse, and a second end is configured to deliver the cleaned used cups. The housing is optionally configured for expansion relative to at least the first end and the second end, via configurable structural components comprising a plurality of braces and exterior skin components, the structural components comprising any of wood, plastic, cloth, and metal. The system further includes a washing apparatus configured to at least one of rinse, wash and dry a plurality of used cups, wherein a separate drying system can be included configured to specifically dry plastic items, and a stacking area configured to stack washed cups into organized arrangement.

Different combinations of two or more of any of the above-noted components, functions, functionality, steps, and structure for the bin embodiments can be interchanged and combined leading to a multitude of additional embodiments.

In some embodiments, a cup return reward method is provided which includes earning a plurality of reuse points to a user upon the user returning one or more cups to one or more designated bins, and redeeming the reuse points for at least one of cash, credit, and one or more products/services with one or more sponsors or designated companies.

Such embodiments can include one and/or another of (and in some embodiments, a plurality of, and in some embodiments, if not mutually exclusive: a majority of, substantially all of, or all of) the following structure, feature, function, step, or clarification, yielding yet further embodiments:
the cup can be any cup, and in some embodiments, can be those of any of the disclosed cup embodiments;
the designated bin can be a bin corresponding to those disclosed in the present disclosure;
washing the returned cups via a washing apparatus included in the one or more designated bins and/or a portable reusing system;
the portable reusing system corresponds to a portable reuse system disclosed in the present disclosure;
one or more processes associated with at least one of reusing one or more cups can be tracked by the user, where the one or more processes are tracked by the user via an application program interface or API, which can comprise an application operated from a mobile device;
the one or more processes are selected from the group consisting of: tracking reuse points, redeeming reuse points, tracking one or more processes directly associated with reusing one or more cups returned by the user, such one or more processes directly associated with reusing comprising returning, washing, rinsing, drying, and returning to service, of the one or more cups returned by the user, and the user's account transaction, balance and/or history;
the API is additionally configured to track one or more, and preferably a plurality of, any physical touchpoints related to the user reusing cups including collection, washing, and redistribution;
the API includes enabling access to a marketplace for company and/or sponsor offers, so that the user can redeem points for such offers;
a QR code included with each cup is scanned via a camera on the user's mobile smart device resulting in the launching of a unique webpage within the user's browser application on the mobile smart device;
the user inputs a phone number and/or email address to claim at least one recycled cup,
an SMS message is sent to the user which includes a link which directs the user to a GUI or webpage for completing a user profile;
the user sends a text message to a predetermined number of an entity managing the awarding of points and redemption thereof, the text message including a number or code for a particular cup for reusing;
in response to the text message, the entity replies with a link to complete an account setup for the user;
a value associated with the at least one cup is retained unless and until it is returned, even, optionally, after the cup has been scanned/red by a smart bin;
and
redeemed value corresponding to the number of points earned is different depending upon what the redeemed value is for (e.g., product, service, cash).

In some embodiments, a reuse reward system is provided and includes at least one server and/or processor having at least one of an application program and computer instructions operating thereon which are configured to cause the at least one server and/or processor to perform any of the methods disclosed herein.

In some embodiments, a non-transitory, computer readable medium having at least one of an application program including computer instructions configured to cause at least one server and/or at least one processor to perform the methods according to any of the disclosed method embodiments, or one or more steps thereof.

At least some of the above noted embodiments will become even more clear with reference the drawings, a brief description of which is provided below, and detailed description.

### BRIEF DESCRIPTION OF THE DRAWINGS

FIG. 1A is a perspective view of a cup according to some embodiments of the present disclosure, the cup can be stackable cup according to some embodiments, with an NFC device;

FIG. 1B is a view of an NFC device, for a cup, according to some embodiments of the present disclosure;

FIG. 1C is a side view of a cup having any and all of an NFC, QR code, and ID number, according to some embodiments of the present disclosure;

FIG. 1D is a perspective view of an NFC reader, and cups having NFC devices, according to some embodiments of the present disclosure;

FIG. 1E is a side view of a plurality of cups for stackable arrangement according to some embodiments of the disclosure;

FIG. 1F is a perspective view of a cup according to some embodiments of the present disclosure, the cup can be stackable cup according to some embodiments, with a QR code;

FIG. 1G is a perspective view of a plurality of cups for stackable arrangement according to some embodiments of the disclosure;

FIG. 1H is an exploded, perspective side view of a stackable arrangement of cups according to some embodiments of the present disclosure;

FIG. 1I is a perspective side view of a stacked, stackable arrangement of cups, illustrating only the bottom of the stack, according to some embodiments of the present disclosure;

FIG. 1J is a cutaway, perspective side view of a stacked, stackable arrangement of cups, illustrating only the bottom of the stack, according to some embodiments of the present disclosure;

FIG. 2A is side view of a smart bin collection device, illustrated with a cup for collection, according to some embodiments of the disclosure;

FIG. 2B is a perspective view of the bin of FIG. 2A illustrating an open door for accessing the interior for removable containers contained therein, according to some embodiments of the present disclosure;

FIG. 2C is a perspective view of a top of the smart bin of FIG. 2A, according to some embodiments of the present disclosure;

FIG. 2D is a side view of a bin according to some embodiments of the present disclosure, illustrating features thereof;

FIG. 2E-1 through FIG. 2E-8 are various perspective views of the door area for receiving cups for the smart bin, according to some embodiments of the disclosure;

FIG. 2F-1 through FIG. 2F-3 are perspective views of the interior of a smart bin, arrangement tray, and stacking apparatus, according to some embodiments of the present disclosure;

FIG. 2G-1 through FIG. 2G-4 are perspective views of a smart bin according to some embodiments of the disclosure, illustrating closed, open, and access/remove of containers therein;

FIG. 2H-1 through FIG. 2H-8 are various views of removable containers according to some embodiments, for use in a smart bin (according to some embodiments);

FIG. 3A is perspective view of a portable, return, washing, and reuse system for reuse of cups, according to the present disclosure;

FIG. 3B is a container apparatus, corresponding to the portable, return, wash, and reuse system, according to some embodiments;

FIG. 3C is the container apparatus of FIG. 3B, corresponding to the portable, return, wash, and reuse system, according to some embodiments, illustrating panels packed inside the container for use as exterior panels;

FIG. 3D is the container apparatus of FIG. 3B, corresponding to the portable, return, wash, and reuse system, according to some embodiments, illustrating panels packed inside the container for use as exterior panels;

FIG. 3E is the container apparatus of FIG. 3B, corresponding to the portable, return, wash, and reuse system, according to some embodiments, illustrating supporting structure, braces, packed inside the container for end-stage extension;

FIG. 3F is a photo of the container with mounted exterior panels, according to some embodiments, being transported via truck;

FIG. 3G is a top view, with top off, of the portable, return, washing, and reuse system, according to some embodiments of the present disclosure;

FIG. 4A an overview diagram of an API for a cup reuse reward method and system, according to some embodiments of the present disclosure;

FIG. 4B is an overview of an onboarding method according to some embodiments of the present disclosure;

FIG. 4C is an overview of another onboarding method according to some embodiments of the present disclosure; and

FIGS. 4D-4P are overviews of methods and/or steps associated with a reuse reward system according to some embodiments of the present disclosure.

### DETAILED DESCRIPTION

While the present disclosure is described herein with reference to illustrative embodiments for particular applications, it should be understood that embodiments of the present disclosure are not limited thereto. Other embodiments are possible, and modifications can be made to the described embodiments within the spirit and scope of the teachings herein, as they may be applied to the above-noted field of the present disclosure or to any additional fields in which such embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

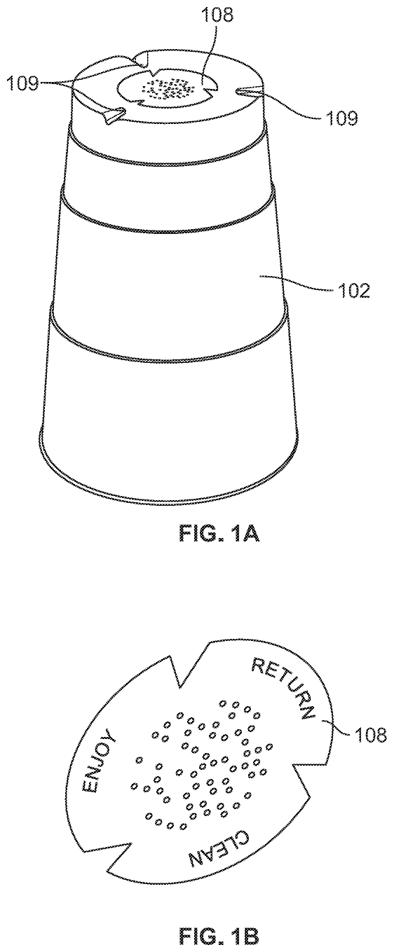

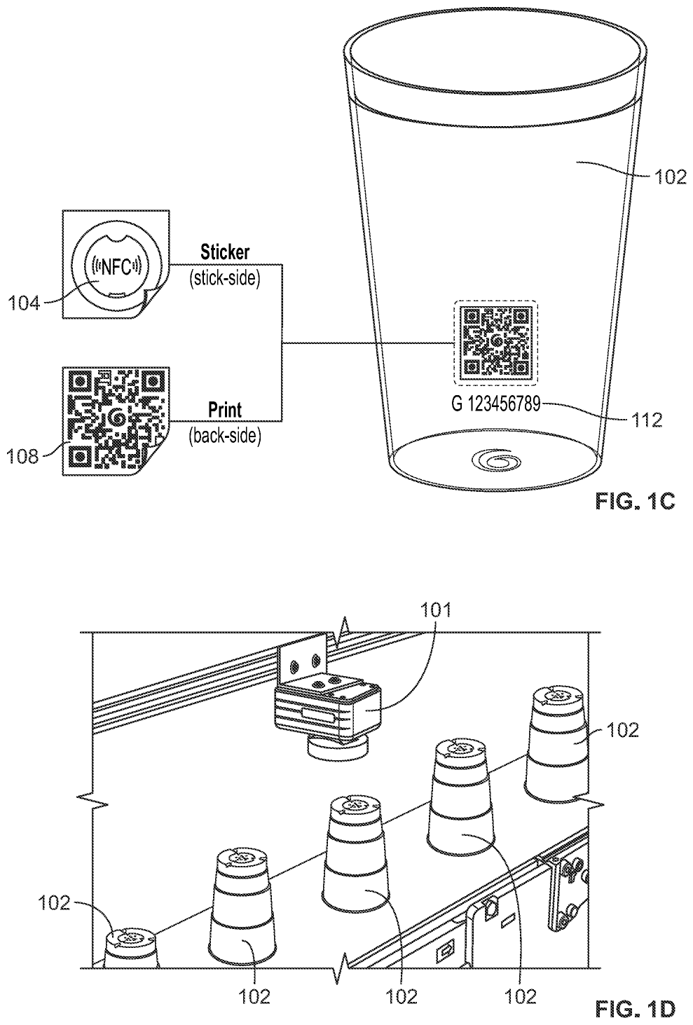

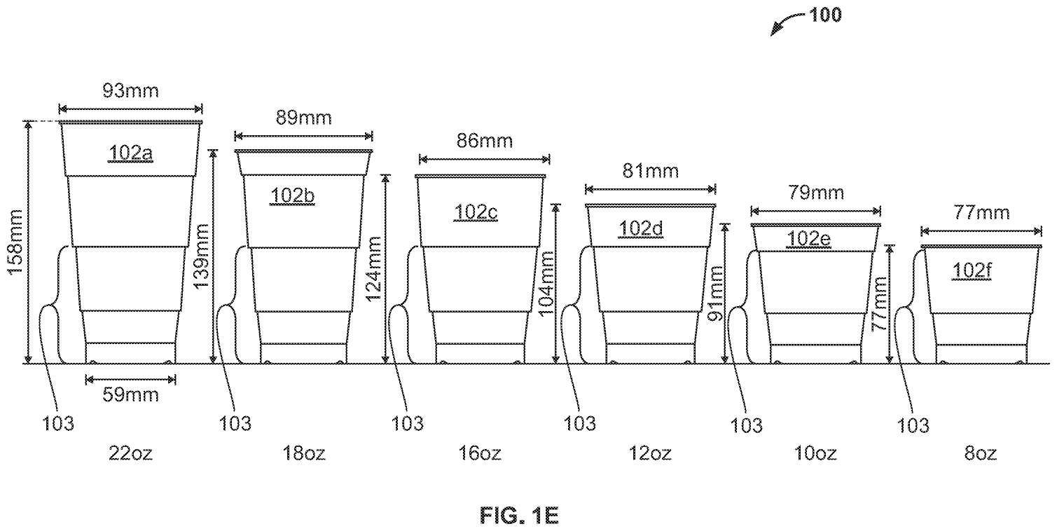

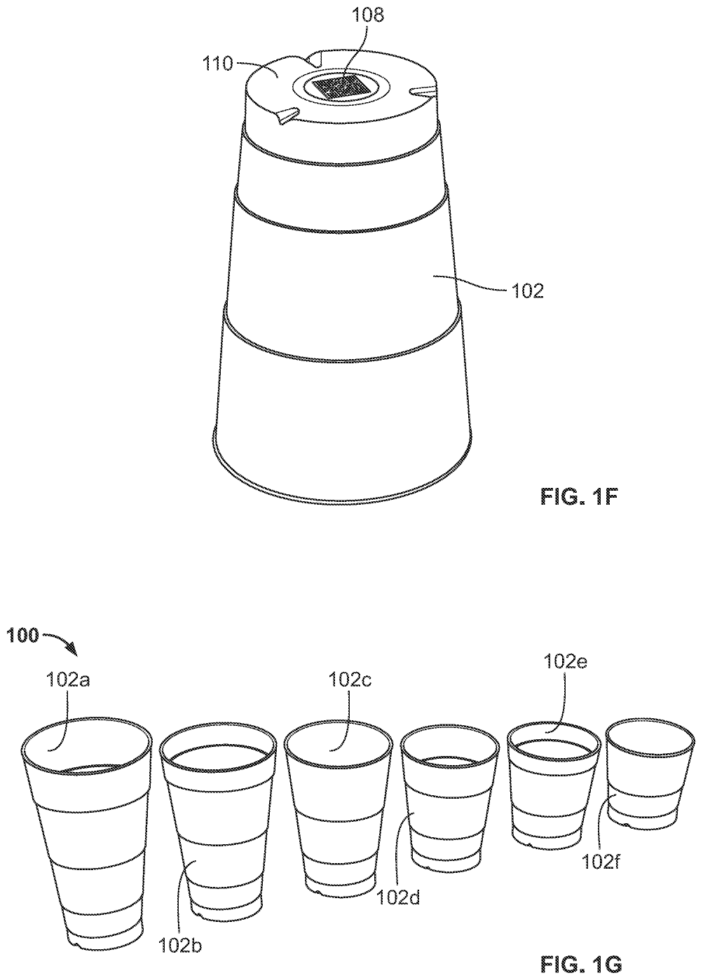

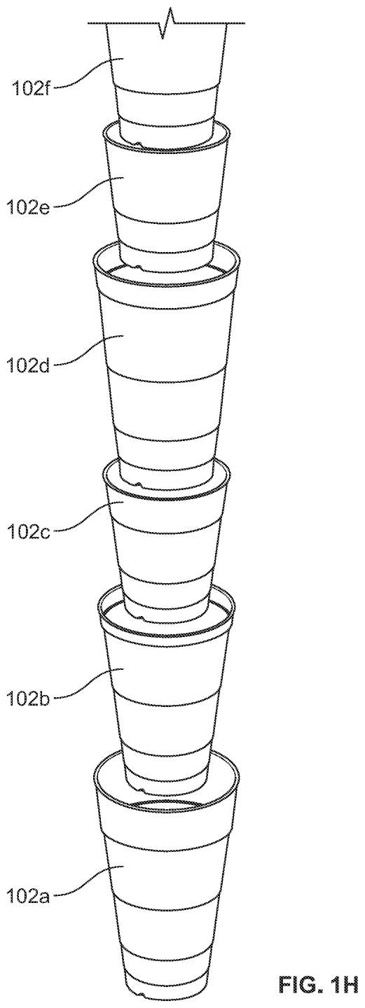

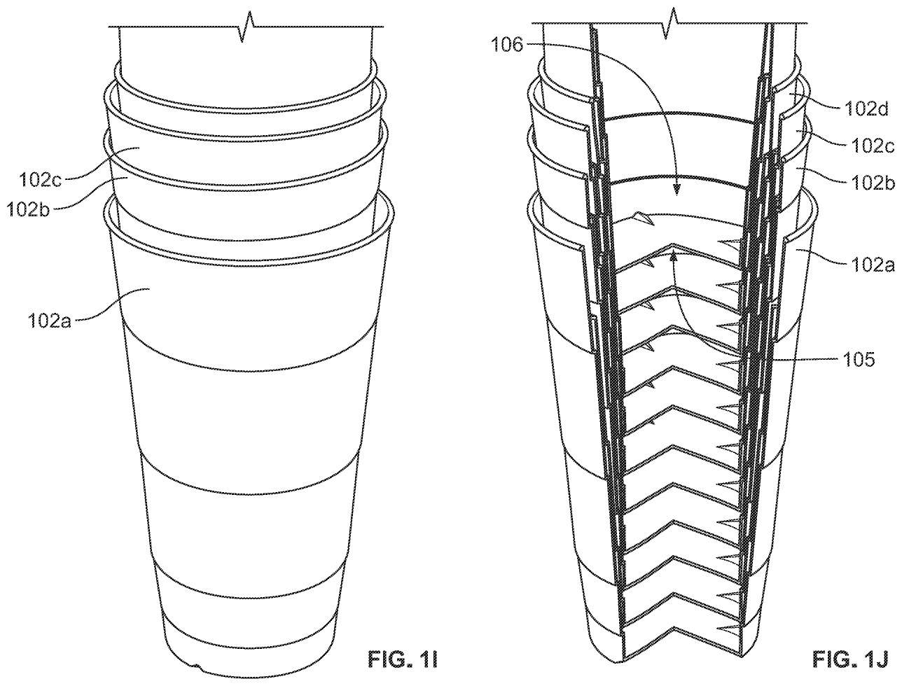

Accordingly, as shown in one and/or another of FIGS. 1A-1J, in some embodiments of the present disclosure, a stackable array 100 of drinking cups comprising a plurality of cups, each cup 102 having a size and shape configured for a nested, stacked arrangement. In some embodiments, each cup 102 includes a near-field-communication/chip (NFC) device 104 positioned within and/or on a portion of each cup/product. In some embodiments, the stackable array does not include NFC structure and/or functionality. As shown in FIG. 1D, each cup 102 can be read by an NFC reader 101 (which may also be a QR code).

In some embodiments, each cup 102 of a corresponding stackable array of cups 100, each of at least two different volume sizes (and in some embodiments, a multitude of varying sizes), for example, cups 102a-f, are configured to be stacked together. Specifically, in some embodiments, each different sized cup includes a portion (e.g., top, middle, and/or bottom) configured to allow for nesting/stacking with any other sized cup, as well as being part of a multi-different volume/sized cup array/stack. For example, as shown in FIG. 1E, the bottom portion 103 of each cup is substantially similar (and in some embodiments, identical), which allows each cup, regardless of the volume it holds (and larger size of the upper portion of each cup, i.e., 102a-f), to be stackable with other corresponding cups. Thus, a smaller (e.g., smallest) volume cup can be stacked immediately adjacent/within a larger (e.g., largest) volume cup, which can also then be stacked (either the larger or smaller) immediately adjacent another volume sized up (or the same volume sized cup). Thus, as shown in FIGS. 1A, 1D-1J, each cup is configured with a tiered arrangement, including at least two tiers, and in some embodiments, two (2) to four (4) tiers (in some embodiments, only two, three, or four tiers).

A plurality of cups can include (and preferably, all cups) the NFC device 104 can be adhered to a bottom surface 110 of each cup (which, in some embodiments, can include a QR code 108 as well, see, e.g., FIGS. 1A-1C, 1F). As shown in FIGS. 1E, 1G, each cup includes a respective and specific height, different from the remainder of the plurality of cups. Additionally, each cup 102 includes a bottom portion 103 including a shape configured to shed water. For example, at least a portion of the bottom portion includes at least one of a concave 105 and convex (not shown) surface configured to shed water. Additionally, a bottom interior surface portion 106 of each cup includes at least one and preferably a plurality of equally spaced raised portions (opposite to indentations 109 on the outside bottom surface (see, e.g., FIG. 1A). The NFC device can be is at least one of (and/or any of): water resistant, clear or with printable back, encoded uniquely to each cup, which is readable via a mobile smart device (e.g., smartphone, which can also be referred to as a phone). The NFC device can be or include a QR code 108 printed thereon, and/or a printed alphanumeric short-code printed thereon. Each cup may also include a hard-stamped/printed ID number 112. The NFC device 104 can be at least one of within and on a portion of each cup. FIG. 1E illustrates exemplary dimensions for each cup of a stalking configuration of cups, each cup configured to contain a predetermined amount of contents.

Each cup can be made of any material having the structural integrity for holding contents (e.g., liquid); accordingly, the cups can be made of plastic (e.g., polypropylene), or metal including steel (e.g., stainless steel), and aluminum.

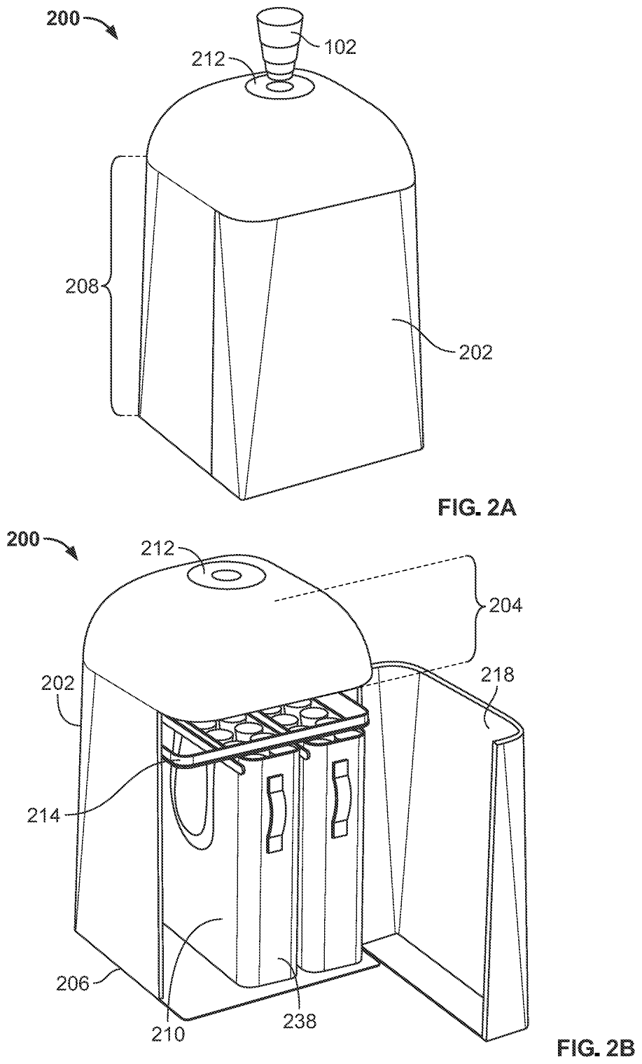

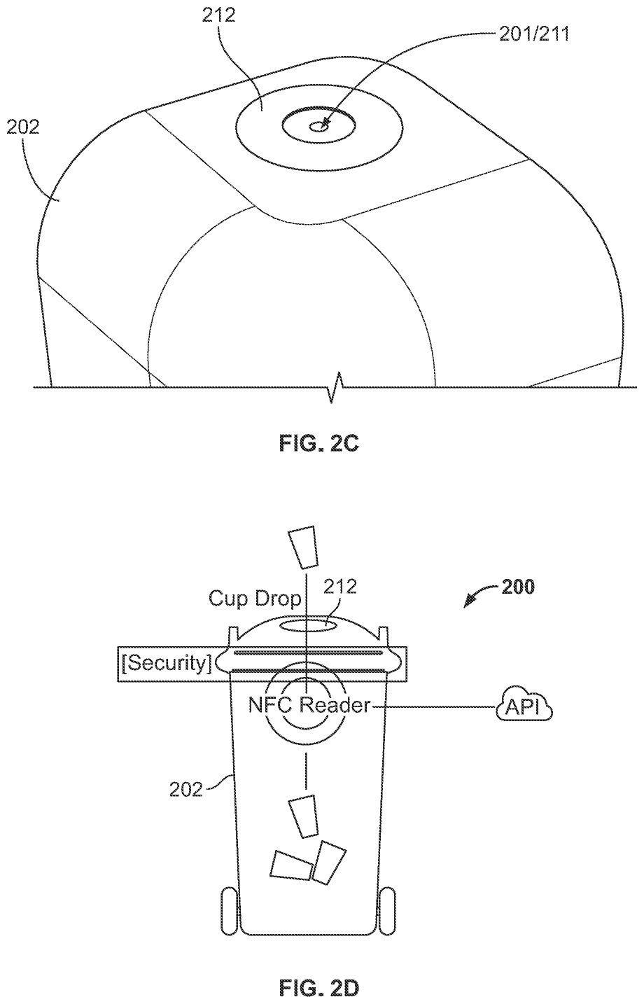

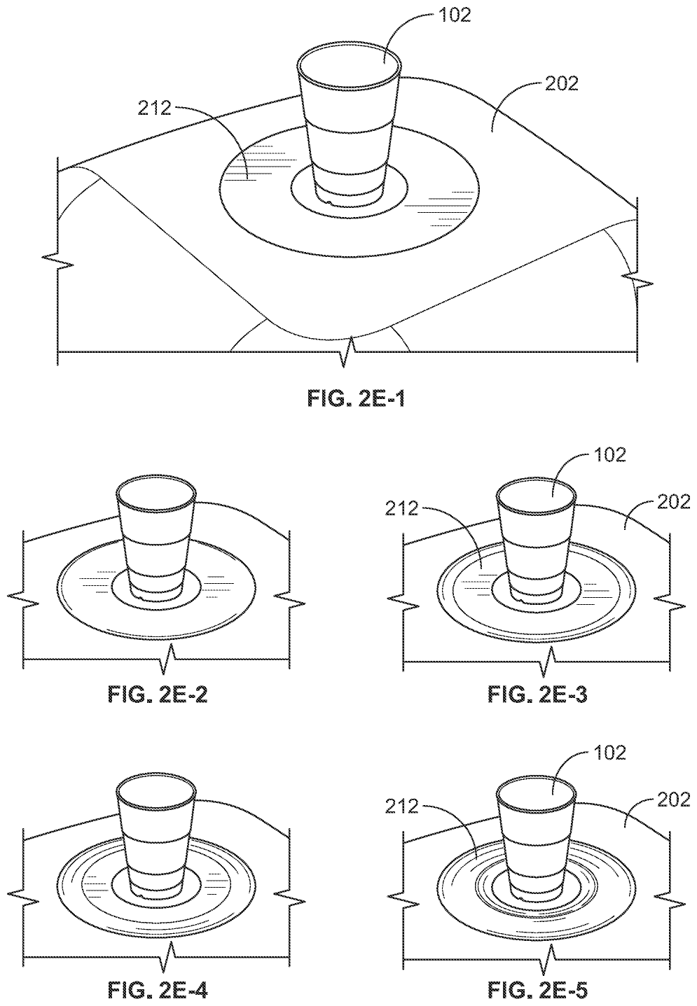

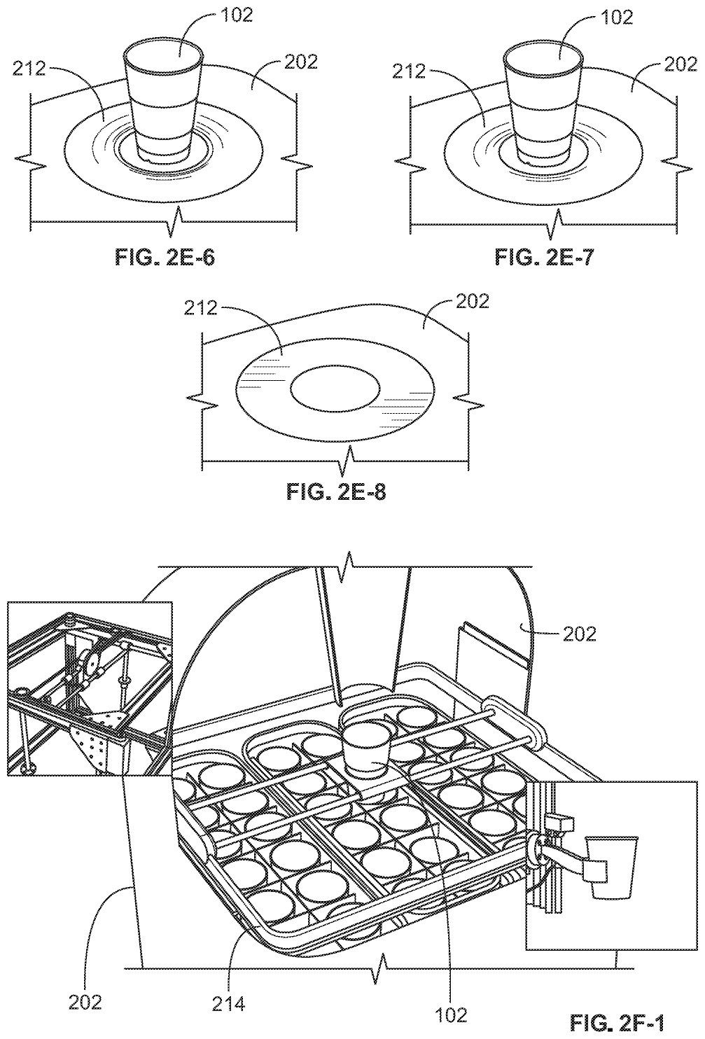

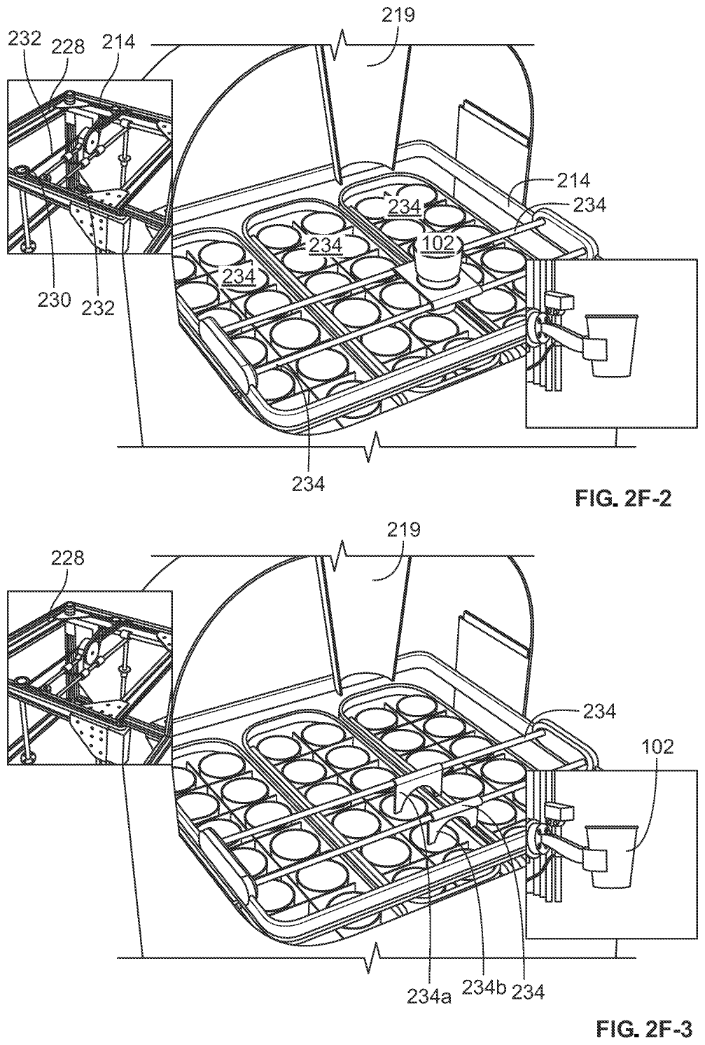

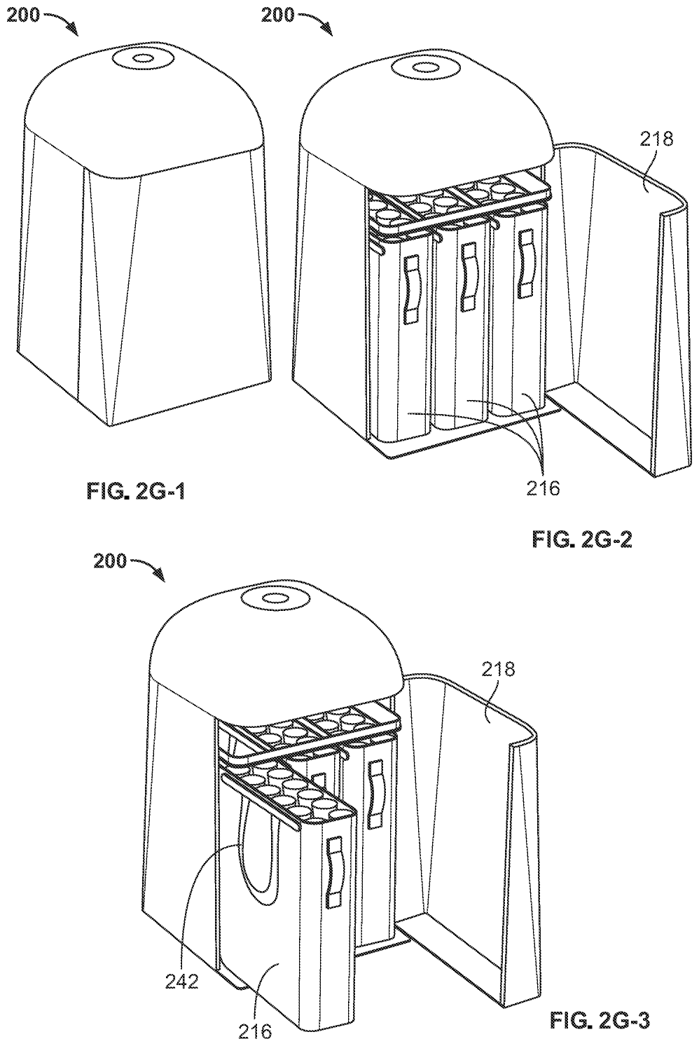

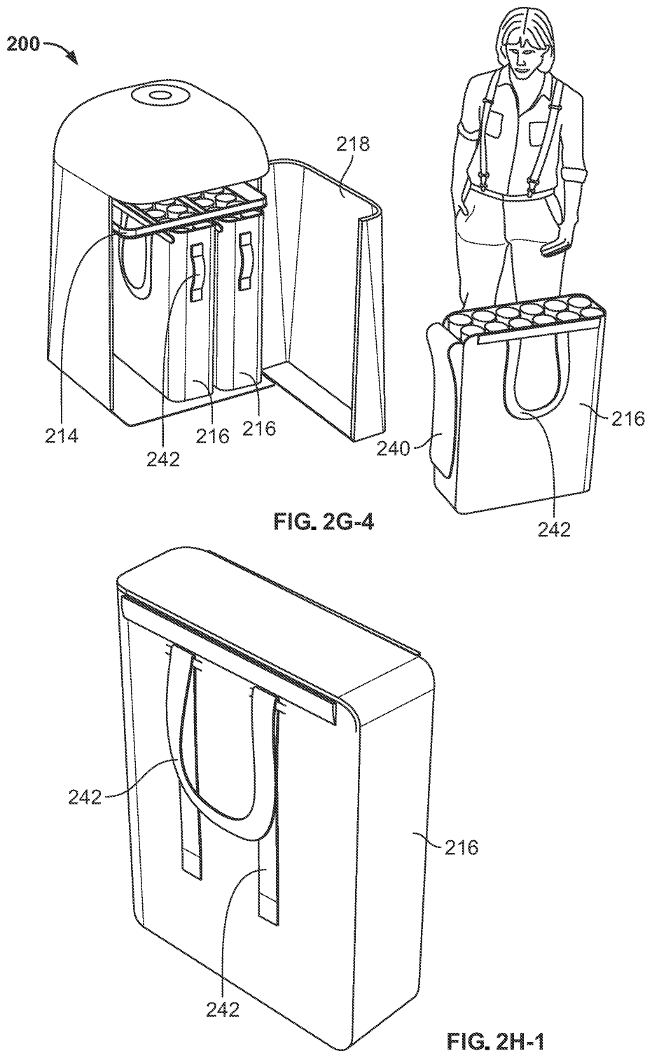

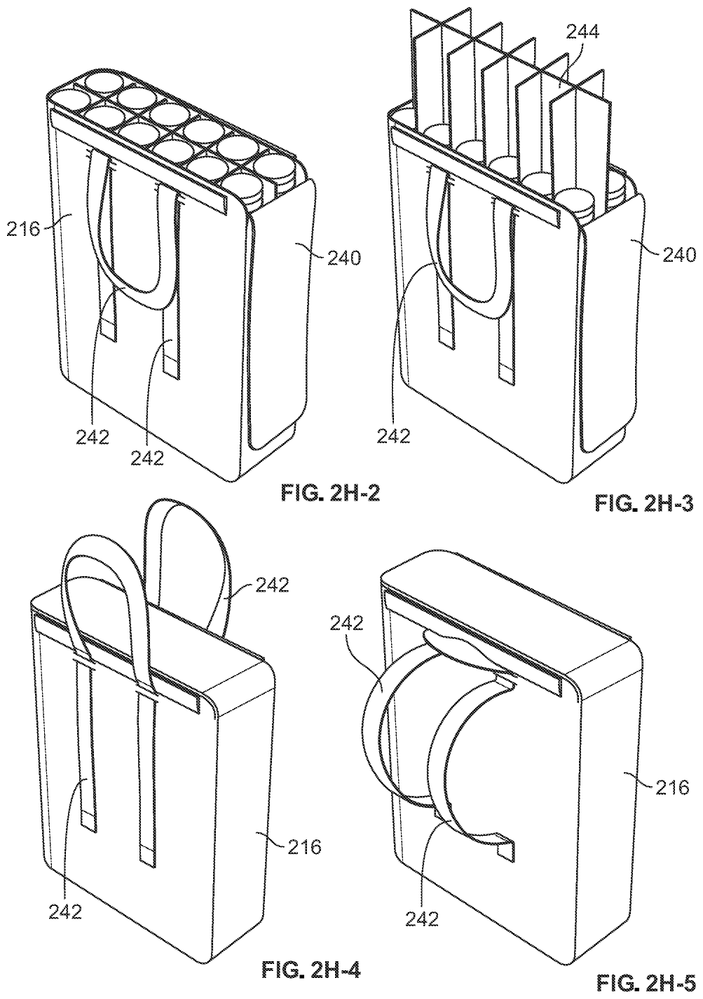

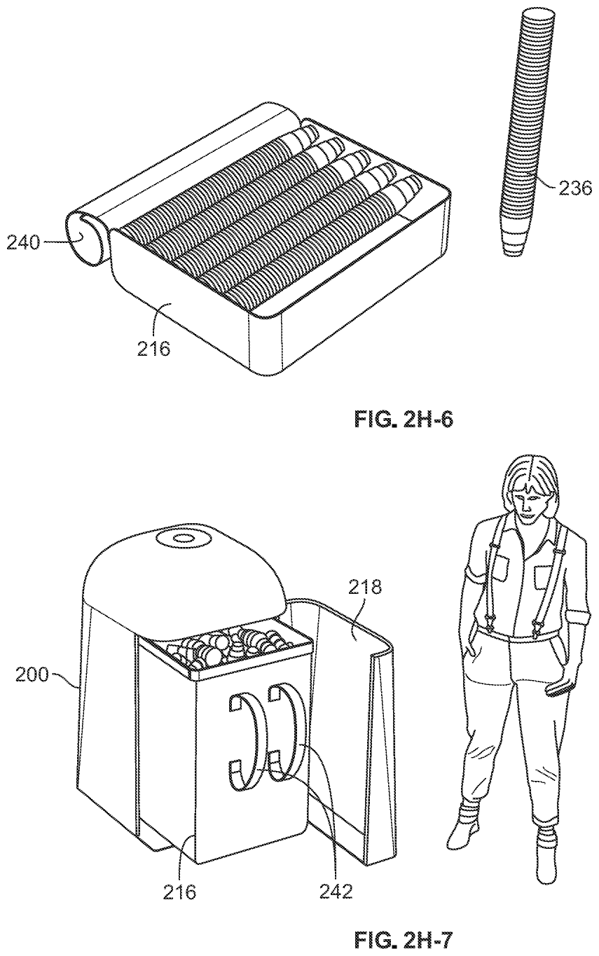

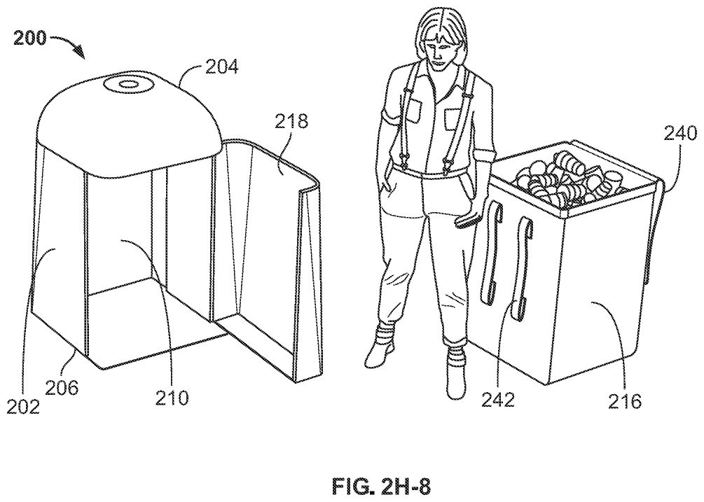

In some embodiments, as shown for example in FIGS. 2A-2H-8, cup receptacle bin 200 is provided (which may also be referred to as a “smart” bin, given that, in some embodiments, electronics and/or communication means are provided for the bin to recognize a cup or other item for collection) and includes a housing 202 having a top end 204, bottom end 206, sides 208, and an interior 210, where the top end includes a door 212 covering a corresponding opening (covered by the door) for receiving at least one cup, an arrangement tray 214 located within the interior, and at least one removable container 216 arranged beneath at least a portion of the arrangement tray (such containers can include a variety of sized to fit within the bin (e.g., 20-100+cm tall, 20-100+cm wide, and 20-100+cm deep).

The at least one removable container 216 optionally includes at least one of a removable cover 218 and one or more carrying straps 242. The bin 200 also includes a visual indicator 212 and a stacking apparatus 228, which can perform at least one of sorting and stacking of cups, configured to place the at least one cup received from the opening/cover area within a location on the arrangement tray 214 upon being received via the opening. The bin 200 can also include a washing apparatus (not shown, but can be configured to be a part of the stacking apparatus 228) configured to at least one of rinse, wash, and dry the at least one cup. Bin 200 can also include a wireless receiver/reader 201 (under/adjacent door 211) configured to sense the at least one cup via the NFC device 104 upon the at least one cup being positioned in proximity to the bin.

Bin 200, according to some embodiments, can be of any size, including, for example, from 30 cm up to 120 cm (and beyond), and may also include widths of e.g., between 20 cm to 100 cm.

The visual indicator 212 is configured to at least one of: indicate the location of the opening for receiving the at least one cup, and indicate an amount of interior space remaining to receive cups. This can be done, for example, by the visual indictor either being of a certain color, repeated blinking, or an animation. In addition, when placing a cup 102 on the cover 211 (upon which, in the illustrated example embodiment the visual indicator is adjacent (e.g., surrounds), the cover can be configured as a “trap door”, i.e., a moving door, and when a cup is placed on the cover 211, the animated light pattern can create a moving, circular pattern moving from the outer circumference to adjacent the door, as shown in FIGS. 2E-1 through 2E-8, until the door 211 opens and the cup is received in the interior of the bin 200.

In some embodiments, those that including washing and/or drying, the NFC 104 for the at least one cup 102 is read prior to washing, after washing, and/or after drying. Optionally, upon completion of cleaning of the cup 102, the data associated with the cup and tracked with the NFC 104 is designated clean, and data associated with a previous user for a respective cup is then scrubbed.

As shown in FIGS. 2F-1 through 2F-3, the stacking apparatus 228 can comprise a 2-axis movement-mechanism, sorting device 228, which includes one or motors, pulleys 230, cables 232, and/or gears for moving the at least one cup received into a respective location of/via the arrangement tray 214. The arrangement tray can be combined with the sorting device 228 such that two parallel bars 234 which includes a 2-part trap/capture member 234a-b, as well as, in some embodiments, any and all of a processor, memory, NFC circuitry, and Bluetooth, cellular, and/or wi-fi communications.

The cup 102 can then slide down an optional funnel member 219 and received by a 2-part trap/capture member 234a-b of the arrangement tray 214 with members 234a-b. Thus, the sorting device includes a processor and access to memory (internal or otherwise), which tracks the stacking arrangement, e.g., as shown in FIGS. 2F-1 to 2F-3 which illustrates a six-by-six stacked arrangement 234 of cups and a number of cups in each vertical stack 236. As shown in FIGS. 2G-1 through 2G-3, and FIGS. 2H-1 through 2H-6, the six-by-six stacked arrangement can be contained by one or more, and preferably a plurality, of interior, removable containers 216. Each removable container 216 includes an internal structure allowing for a stacked arrangement of cups received by the bin. To this end, at least one of the top end, the bottom end, and (one or more) a side of the container 216 is configured for opening 218 (the top end, bottom end, and/or side being a door 218 to the opening) to remove the received at least one cup 102. Each removable container 216 optionally including at least one of a removable cover 240 (e.g., top, bottom, or a side) and one or more carrying straps 242 (which can be any kind of carrying strap or handle, e.g., backpack straps, etc.). Additionally, the removable container 216 can include one or more, and preferably, a series of dividers 244 so as to keep adjacent stacks of cups 102/100 apart. FIGS. 2H-7 and 2H-8 illustrate a removable container which receives loose cups which are not arranged by a stacking apparatus.

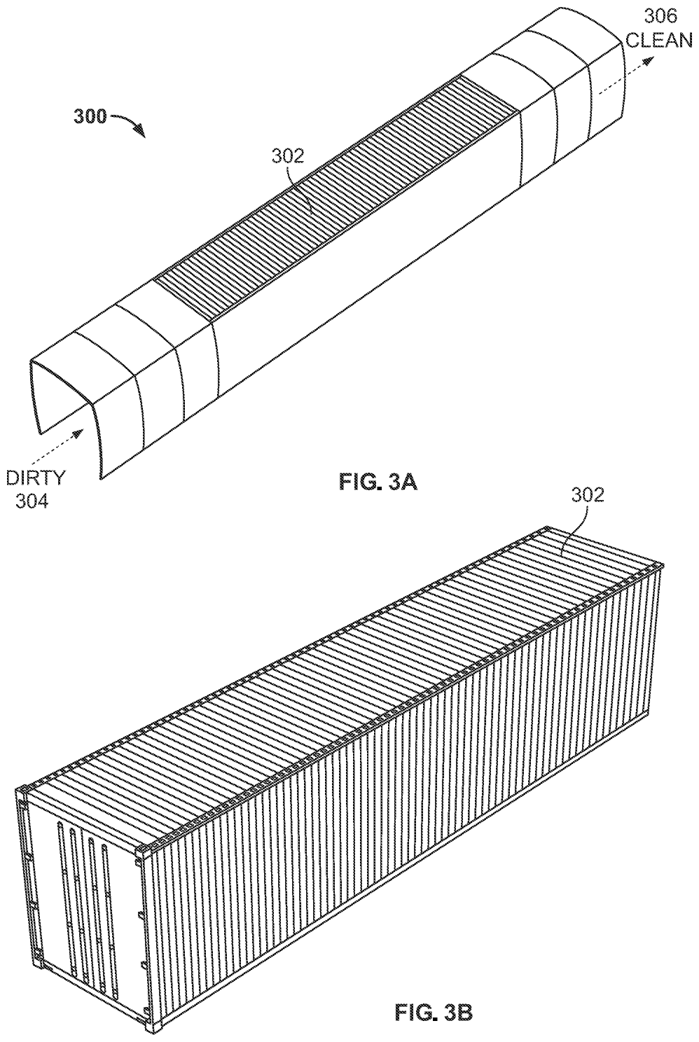

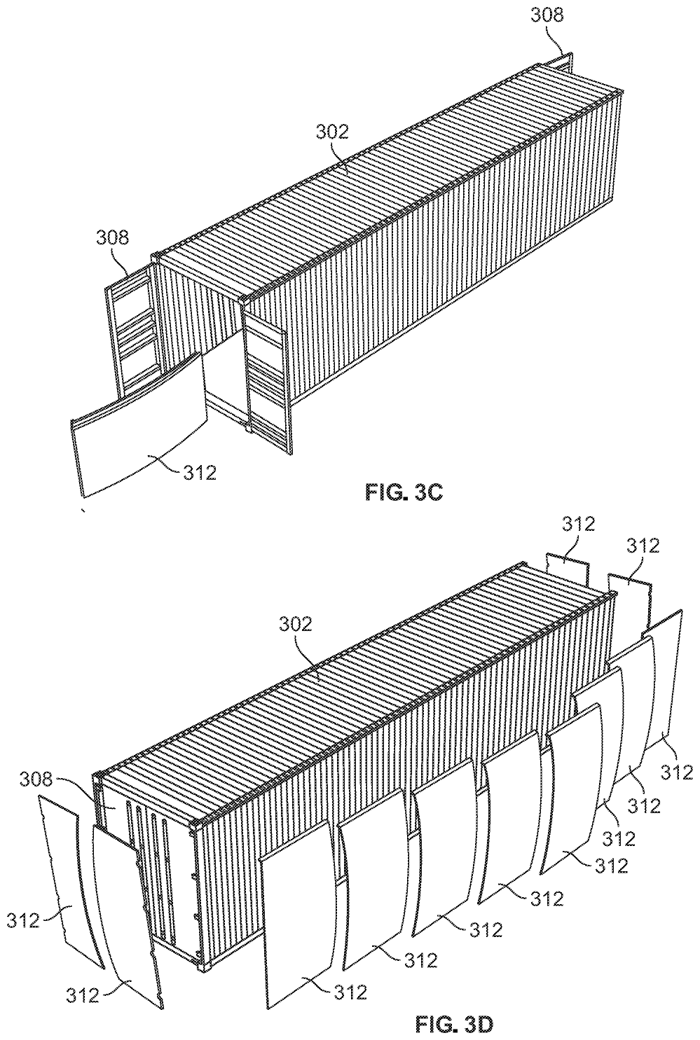

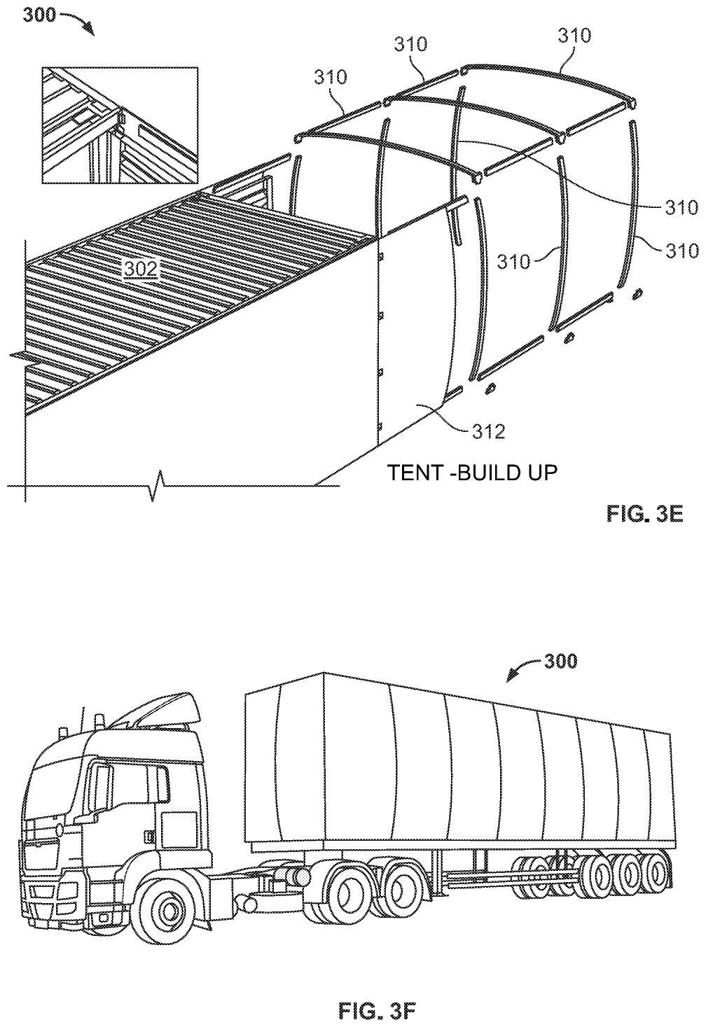

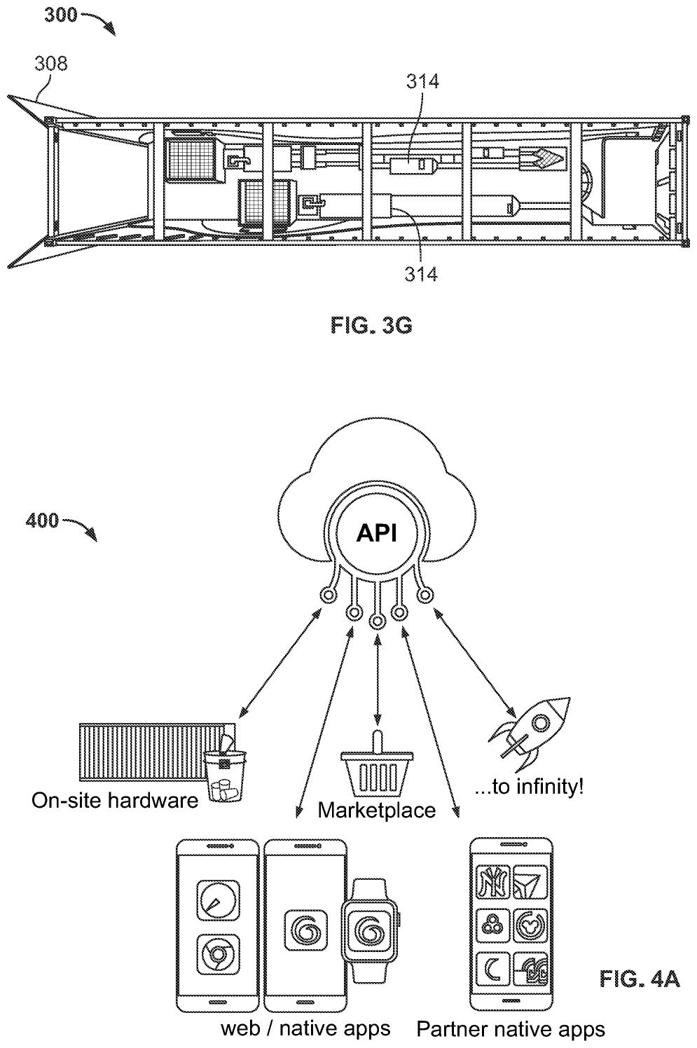

In some embodiments of the present disclosure, as shown in FIGS. 3A-G, a portable drinking cup reuse system 300 is provided and includes a portable housing 302 having a size and shape to accommodate at least one person, the housing include a first end 304 and a second end 306 and configured for automotive/truck transport (for example), and at least one door 308 included on at least one of the first end 304 and the second end 306. The first end 304 is configured to receive used cups for reuse, and a second end 306 is configured to deliver the used cups after being cleaned and sterilized. The housing 302 is optionally configured for expansion relative to at least the first end 304 and the second end 306, via configurable structural components comprising a plurality of braces 310 and exterior skin components 312, the structural components comprising any of wood, plastic, cloth, and metal. The system can also include a washing apparatus 314 configured to at least one of, and any of (and preferably all of) rinse, wash and dry cups (in some embodiments, a separate drying apparatus can be provided), and a stacking area configured to stack recycled cups into organized arrangement. The system of FIGS. 3A-G can be configured to perform a corresponding method for collecting, washing and sterilizing cups, optionally drying the cups, for reuse. Such a method can be used, in combination with the system, at public events such as concerts, fairs, and the like, to help, for example, minimize waste.

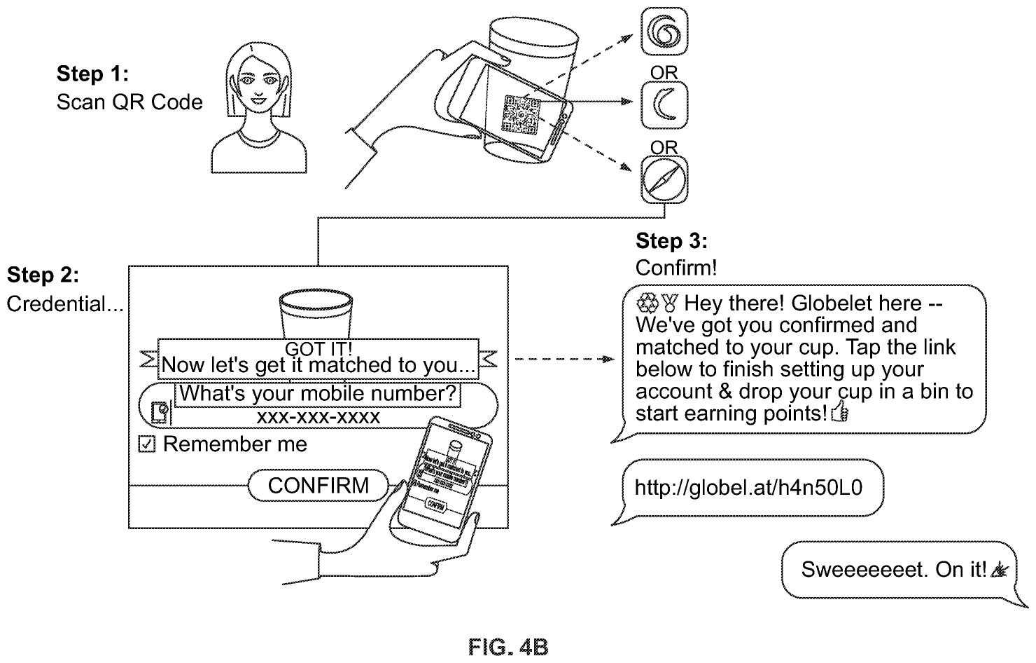

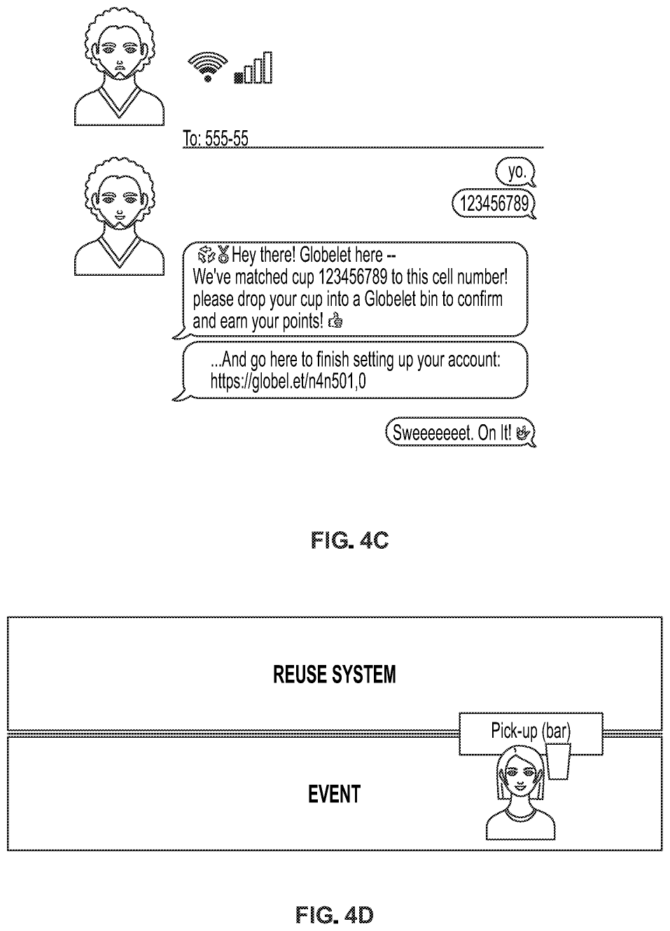

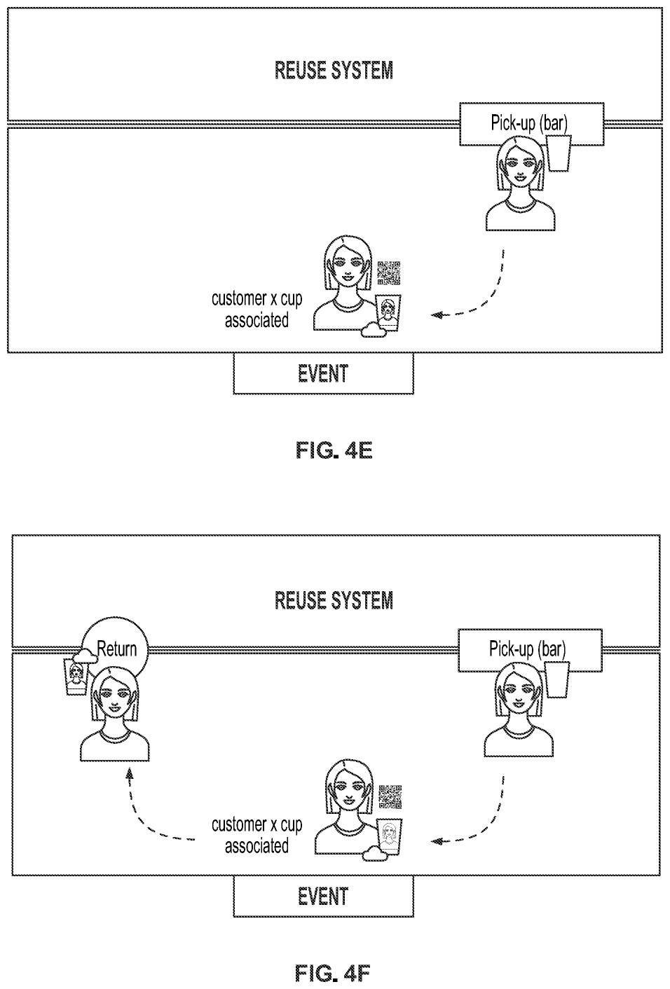

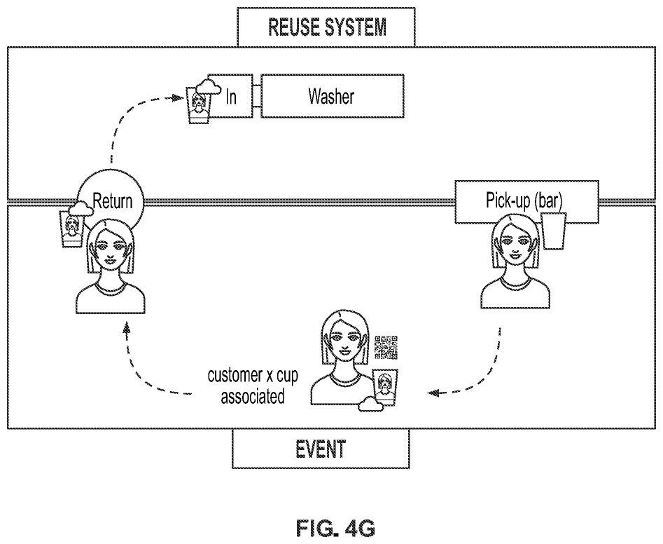

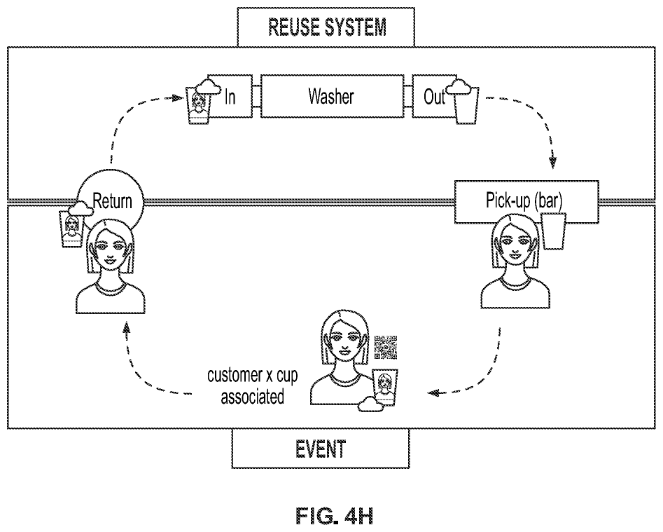

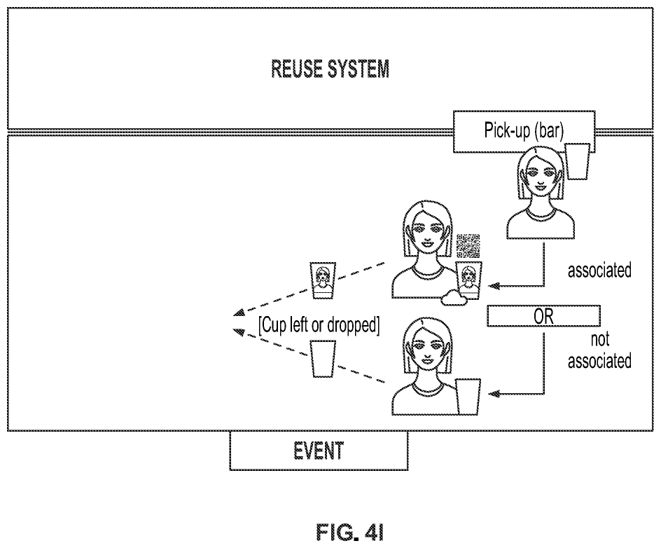

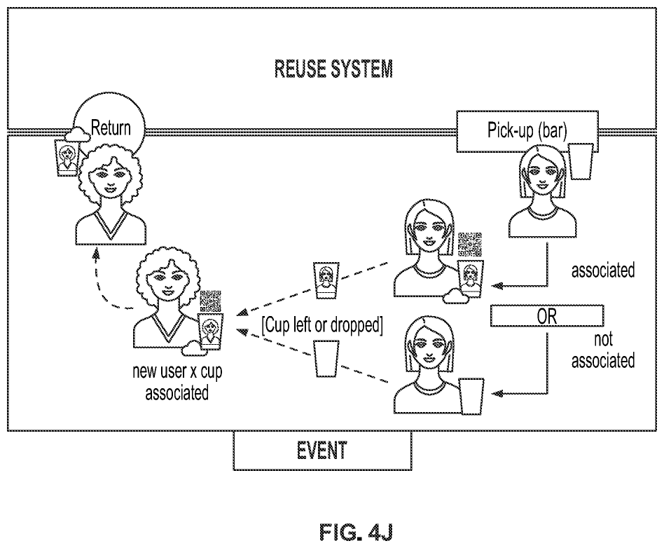

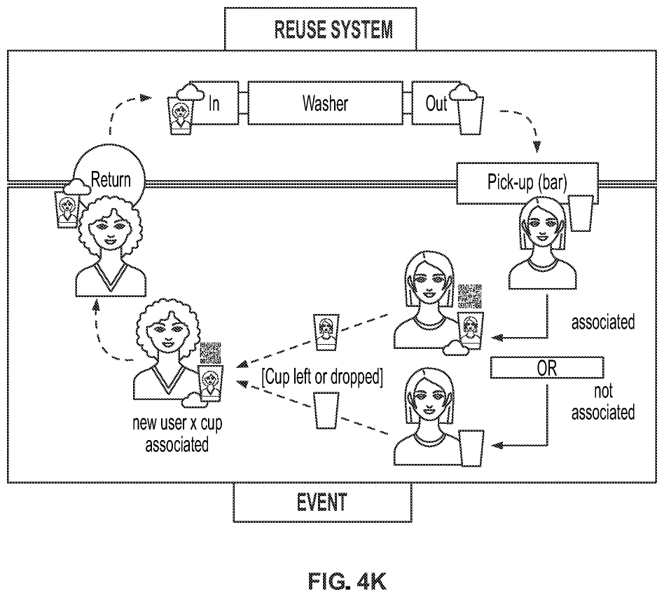

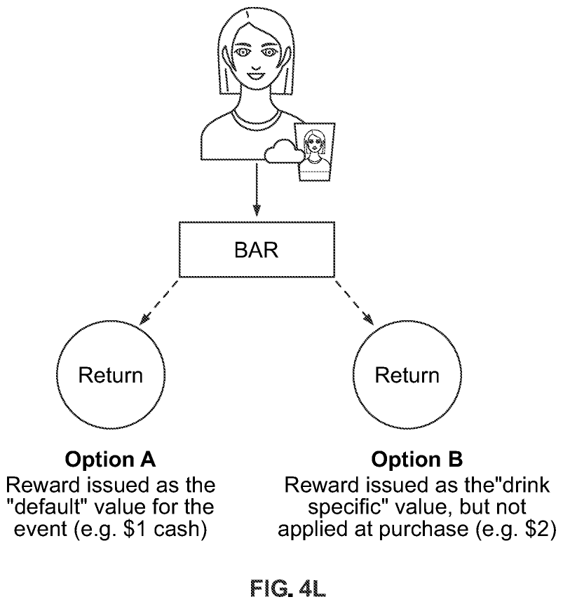

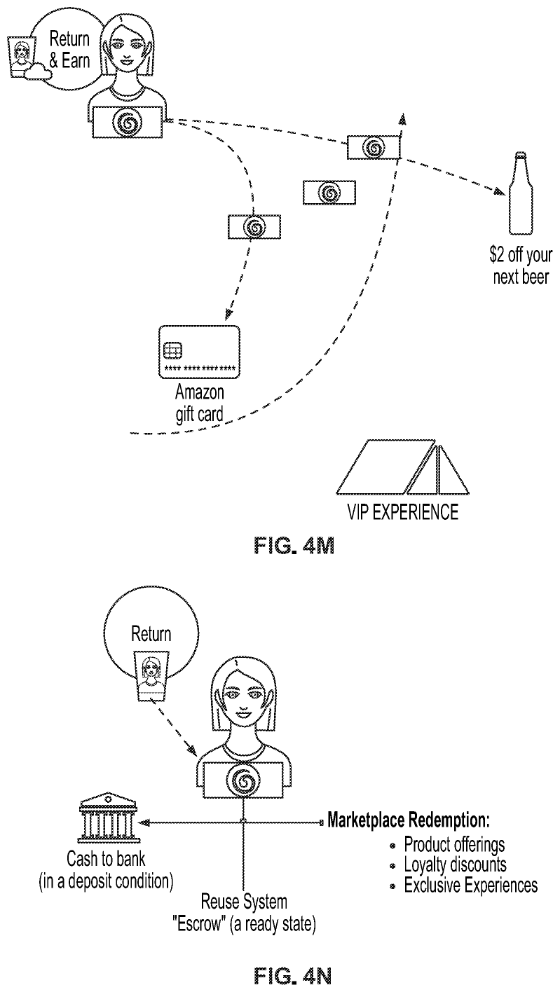

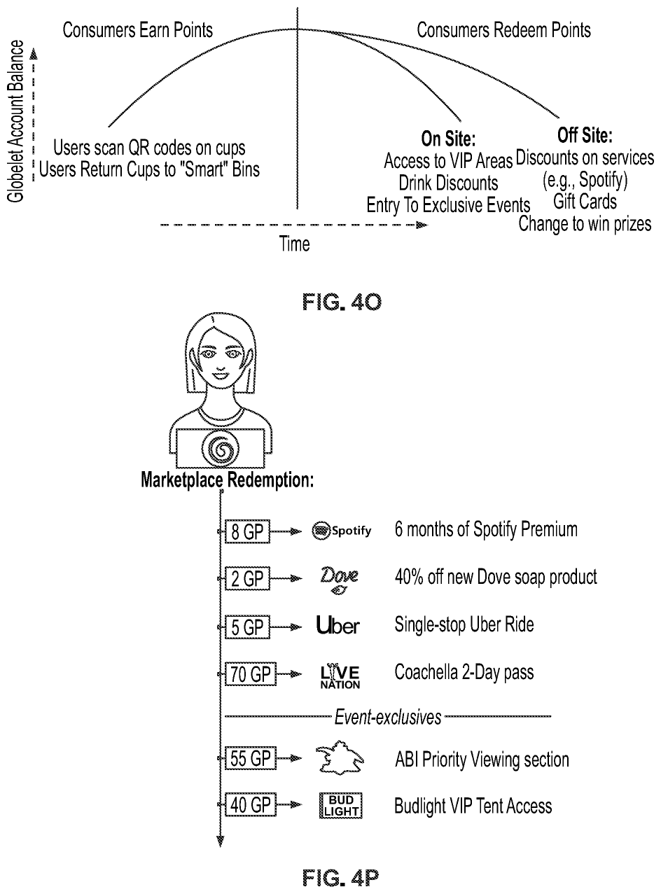

In some embodiments, a cup reuse reward method is provided which includes earning a plurality of reuse points for each user upon the user returning one or more cups to one or more designated bins. The user can then redeem the reuse points for at least one of cash, credit, and one or more products/services with one or more sponsors or designated companies. An example of such a reuse method and system are illustrated in FIGS. 4A-4P.

As shown in FIG. 4A, the method can be associated with a system 400 where one or more application program interfaces, including those for on-site hardware (e.g., see bin system of FIGS. 2A through 2H-8, and portable reuse system of FIGS. 3A-G), a marketplace where users can use points collected from reuse of cups to purchase goods for example, from partnering with companies via, for example, one or more native applications on a smartphone (for example).

As shown in FIG. 4B, using a camera app on their phone, at Step 1, a user scans a QR code, which launches a unique webpage within the user's browser application on his/her phone. At Step 2, on the webpage, the user can enter her phone number and/or email address in order to associate her cup(s) with her account (a user can claim multiple cups during such a session or any session). At Step 3, thereafter, an SMS message can be sent to the user containing a link prompting them to complete a profile with remaining, optional fields, at their leisure.

The user mobile application, according to some embodiments, can include, or be associated with, a web application (as indicated above), SMS functionality, partnering applications, and auditing applications (for example).

Alternatively, as shown in FIG. 4C, wherein connectivity is unreliable, and where the user is at an event, event communications can identify a special text number that users can text their cup ID number to. This allows the system to both log the cup ID and identify the user, and associate the two together. A link to setup an application on the user's phone can then be returned, which would allow the user to setup an account when connectivity permits. Moreover, in such embodiments, the system could operate a raffle or prizes, and alert a user that she has won by directing an SMS to the user (who previously sent the cup ID to the special text number).

In an event user scenario, for example, and according to some embodiments, as shown in FIG. 4D, a user purchases a drink (e.g., a beer), which is contained in one of the cups 102 according to some embodiments (or other cup). As noted above, the user scans the QR code to claim the value of the cup in their account as shown in FIG. 4E. When the user is finished with her beverage, the user can then return the cup to a smart bin, such as the bin 200 described above and illustrated in FIGS. 2A-2G-4. Once the user places her cup on or near the door 212, the bin 200 detects the NFC chip (and/or in some embodiments, scan's the QR code via a scanning device located on the bin), and the door is opened and the cup is received by the tray 214 and stacking apparatus 228, thus confirming the cup's presence in the bin. The bin 200 then registers the cup's successful return with the API; see FIGS. 4D-4F.

The returned cups can then enter the smart washing system of FIGS. 3A-G. In some embodiments, this allows for the tracking of cup inventory (as well as in some instances, a redundancy in case of bin failures). Cups coming out of the smart washing system come out clean, sterilized, and their associated NFC chips scrubbed of any user data. Each cup then can be reused ready to be scanned and returned by someone new, and can enter and exit the washing system as described above. See FIGS. 4G-4I, and FIG. 4K.

In some embodiments, a cup retains its value until it is successfully returned. If a user “drops” their cup after scanning it, and doesn't return the cup, the cup functions as though it has never been scanned. Another user (or anyone else) can then pick up the dropped cup, scan it, and return it to a bin to claim the associated cup value/reward/points from themselves. See FIGS. 4I-J. In some embodiments, if a user returns a cup to the bar (where beverages are purchased), the bartender can simply place the cup into a return bin behind the bar. Such return bins can be coded to issue the user a predetermined reward reflecting the fact that the cup was returned. See FIG. 4L.

In some embodiments, collected reward/points are established as a currency, which a user can spend (e.g., via a reward on the mobile application for example). Such reward points, similar to, for example, credit-card reward points, can be used to purchase, for example, discounted beverages at an event, or gift cards and the like. See FIG. 4M. The value of such points can be determined by an event planner or other party with interest in the system or partners (e.g., consumer brands). See FIGS. 4N-P. For example, as shown in FIG. 4P, certain points (“GP”) are associated with certain items (e.g., 8 GP/points—6 months of Spotify, 2 GP—40% discount on a bar of soap; 70 GP— a day pass to a concert, and so on). Brands can influence the attractiveness of their rewards and user can engage in speculative or arbitrage behavior, collectively creating a more valuable and efficient market. Moreover, methods and systems according to some embodiments, can generate user data about consumption and use patterns (e.g., average time between purchase and discard, as well as product adjacencies), data associated with prevalence and/or value of product or packaging types, which such collection of data can be monetized in a variety of ways, including, for example, advertising and user acquisition campaign.

The above noted embodiments thus can include one or more (and in some embodiments, a plurality of, in some embodiments, a majority of, in some embodiments, substantially all of, and in some embodiments, all of) of the following functionality:
tracking and/or reusing points;
redeeming and/or reusing points;
tracking one or more processes directly associated with reusing one or more cups returned by the user, such one or more processes directly associated with reusing comprising returning, washing, rinsing, drying, and returning to service, of the one or more cups returned by the user;
a user's account transaction, balance and/or history;
an API that is configured to track one or more, and preferably a plurality of, any physical touchpoints related to the user reusing cups including collection, washing, and redistribution;
an API which includes enabling access to a marketplace for company and/or sponsor offers, so that the user can redeem points for such offers;
a QR code included with each cup is scanned via a camera on the user's mobile smart device resulting in the launching of a unique webpage within the user's browser application on the mobile smart device;
user input of a phone number and/or email address to claim at least one recycled cup;
an SMS message is sent to the user which includes a link which directs the user to a GUI or webpage for completing a user profile;
user text message to a predetermined number of an entity managing the awarding of points and redemption thereof, the text message including a number or code for a particular cup for reusing;
a response to the text message, the entity replies with a link to complete an account setup for the user;
a value associated with the at least one cup is retained unless and until it is returned, even, optionally, after the cup has been scanned/red by a smart bin;
and
the redeemed value corresponding to the number of points earned is different depending upon what the redeemed value is for (e.g., product, service, cash);

In some embodiments, a reuse reward system is provided and comprises at least one server and/or processor having at least one of an application program and computer instructions operating thereon which are configured to cause the at least one server and/or processor to perform any of the method disclosed herein.

In some embodiments, a non-transitory, computer readable medium is provided, which includes at least one of an application program and computer instructions operating thereon which are configured to cause at least one server and/or at least one processor to perform any of the methods disclosed herein.

Embodiments of the present disclosure may be or use one or more of a device, system, method, and/or computer readable medium at any possible technical detail level of integration. A computer readable medium may include a computer readable storage medium (or media) having computer readable program instructions thereon for causing a processor to carry out one or more aspects of the present disclosure. Such computer readable (storage) medium can be a tangible device that can retain and store instructions for use by an instruction execution device, and may also be, but not limited to, a memory as detailed earlier in this disclosure (e.g., an electronic storage device, a magnetic storage device, an optical storage device, an electromagnetic storage device, a semiconductor storage device, or any suitable combination of the foregoing, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, in accordance with embodiments of the present disclosure.

Method embodiments (as well as one or more steps thereof) can be configured as computer readable program instructions (corresponding to the steps/methods) and can be downloaded to respective computing/processing devices from a computer readable storage medium or to an external computer or external storage device via a network, for example, the Internet, a local area network, a wide area network and/or a wireless network.

Computer readable program instructions for carrying out operations (e.g., steps) of at least some of the embodiments disclosed herein of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform various aspects of the present disclosure.

Aspects of the present disclosure are described sometimes with reference to a flow, a flow diagram, and/or block diagram of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions, operable, for example, on one or more components (e.g., server(s), processor(s)). These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks, in accordance with embodiments of the present disclosure.

Any flowchart and block diagrams of the present disclosure are examples of architecture, functionality, and operations, of at least some of the embodiments of systems, methods, and computer readable media supported herein. In this regard, each block in the flowchart or block diagrams may represent a module, segment, or portion of instructions, which includes one or more executable instructions for implementing the specified logical function(s). In some embodiments, the functions noted in the blocks may occur out of the order as those noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be understood that at least some embodiments of the present disclosure can correspond to a cloud computing environment, but are not so limited, as embodiments of the present disclosure are capable of being implemented in conjunction with any other type of computing environment now known or later developed. With respect to a cloud computing environment, such is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

While various inventive embodiments have been described and illustrated herein, those of ordinary skill in the art will readily envision a variety of other means, steps, and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant only to be examples and that actual parameters, dimensions, materials, and configurations will depend upon the specific application or applications for which the inventive teachings is/are used. Those skilled in the art will also recognize, or be able to ascertain using no more than routine experimentation, many equivalents to the specific inventive embodiments described herein. It is, therefore, to be understood that the foregoing disclosed embodiments are presented by way of example only and that, within the scope of claims supported by the present disclosure (including equivalents thereto), inventive embodiments may be practiced otherwise than as specifically described and claimed.

Some of the inventive embodiments of the present disclosure are directed to each individual feature, system, article, material, kit, method, and step, described herein. In addition, any combination of two or more such features, systems, articles, materials, kits, methods, and steps, if such features, systems, articles, materials, kits, methods, and steps, are not mutually inconsistent, is included within the inventive scope of the present disclosure. Some embodiments disclosed herein may also be combined with one or more features, as well as complete systems, devices or methods of other embodiments (as well as known systems, devices, or methods) to yield yet other embodiments and inventions. Moreover, some embodiments, may be distinguishable from the prior art by specifically lacking one and/or another feature disclosed in the particular prior art reference(s); i.e., claims to some embodiments may be distinguishable from the prior art by including one or more negative limitations.

Also, as shown above, various inventive concepts may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to) for a particular embodiment(s).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is currently claimed:

1. A drinking cup receptacle bin comprising:
a housing including a top end, bottom end, a side, and an interior, wherein the top end includes a door covering a corresponding opening for receiving at least one cup at a time;
an arrangement tray located within the interior;
at least one removable container arranged beneath at least a portion of the arrangement tray, the at least one removable container optionally including at least one of a removable cover and carrying straps;
a visual indicator;
a stacking apparatus configured to place the at least one cup within a location on the arrangement tray upon being received via the opening;
and
a wireless receiver configured to sense the at least one cup via near-field communication/chip (NFC) upon the at least one cup being positioned in proximity to the bin;
wherein:
the visual indicator is configured to at least one of:
indicate the location of the opening for receiving the at least one cup; and
indicate an amount of interior space remaining to receive cups;
the wireless receiver is arranged on or within the door, such that, upon the at least one cup being placed on the door, the door opens allowing the at least one cup to be received within the interior,
the stacking apparatus comprises a 2-axis mechanism for moving the at least one cup received into a respective location of the arrangement tray;
the at least one removable container includes an internal structure allowing for a stacked arrangement of cups received by the bin; and
at least one of the top end, the bottom end, and the side are configured for opening to remove the received at least one cup.

2. A drinking cup receptacle bin comprising:
a housing including a top end, bottom end, a side, and an interior, wherein the top end includes a door covering a corresponding opening for receiving at least one cup;
at least one removable container arranged beneath at least a portion of the arrangement tray;
a visual indicator;
a wireless receiver configured to sense the at least one cup via near field communications/chip (NFC) upon the at least one cup being positioned in proximity to the bin;
wherein:
the visual indicator is configured to at least one of:
indicate the location of the opening for receiving the at least one cup; and
indicate an amount of interior space remaining to receive cups;
the wireless receiver is arranged on or within the door, such that, upon the at least one cup being placed on the door, the door opens allowing the at least one cup to be received within the interior,
at least one of the top end, the bottom end, and the side are configured for opening to remove the received at least one cup.

3. The bin of claim 18, further comprising at least one of:
an arrangement tray located within the interior;
a stacking apparatus configured to place the at least one cup within a location on the arrangement tray upon being received via the opening; and
wherein:
the at least one removable container optionally including at least one of a removable cover and carrying straps;
the at least one container includes carrying straps;
the stacking apparatus comprises a 2-axis mechanism for moving the at least one cup received into a respective location of the arrangement tray;
the at least one removeable container includes an internal structure allowing for a stacked arrangement of cups received by the bin.
the NFC for the at least one cup is read prior to cleaning, and upon completion of cleaning, the cup and associated NFC is designated clean and data associated with the user for a respective cup is then scrubbed;
the stacking apparatus comprises a 2-axis mechanism for moving the at least one cup received into a respective location of the arrangement tray; and/or
the at least one removable container includes an internal structure allowing for a stacked arrangement of cups received by the bin.

4. A portable drinking cup reuse system comprising:
a portable housing having a size and shape to accommodate at least one person, the housing include a first end and a second end and configured for automotive/truck transport;
at least one door included on at least one of the first end and the second end;
the first end is configured to receive used cups for cleaning and reuse;
a second end is configured to deliver the cleaned used cups;
wherein:
the housing is optionally configured for expansion relative to at least the first end and the second end, via configurable structural components comprising a plurality of braces and exterior skin components, the structural components comprising any of wood, plastic, cloth, and metal;
a washing apparatus configured to at least one of rinse, wash and dry a plurality of used cups, wherein a separate drying system can be included configured to specifically dry plastic items;
and
a stacking area configured to stack washed cups into organized arrangement.

5. A stackable array of drinking cups comprising a plurality of cups, each cup having a size and a shape configured for a nested, stacked arrangement with one-another, wherein each cup includes a near-field-communication/chip (NFC) device positioned within and/or on a portion of each cup.

6. The array of claim 5, wherein the NFC device is affixed to a bottom surface of each cup.

7. The array of claim 5 or 6, wherein each cup includes a respective and specific height, different from the remainder of the plurality of cups.

8. The array of any of claims 5-7, wherein each cup includes a bottom portion which includes a shape configured to shed water.

9. The array of claim 8, wherein at least a portion of the bottom shape comprises at least one of a concave and convex surface configured to shed water.

10. The array of any of claims 5-9, wherein a bottom interior surface portion of each cup includes at least one and preferably a plurality of equally spaced raised portions.

11. The array of any of claims 5-10, wherein the NFC device is at least one and any of:
water resistant;
clear or with printable back;
encoded uniquely to each cup;
is readable via a mobile device;
includes a QR code printed thereon; and
an alphanumeric short-code printed thereon.

12. The array of any of claim 5-11, wherein each cup includes a stamped or printed ID number.

13. A drinking cup including a near-field-communication/chip (NFC) device at least one of within and on a portion of each cup.

14. The cup of claim 13, wherein the NFC device is adhered to a bottom surface of the cup.

15. The cup of any of claims 13-14, wherein the cup includes a bottom portion having a shape configured to shed water.

16. The cup of any of claims 13-15 wherein at least a portion of the bottom shape comprises at least one of a convex and concave surface configured to shed water.

17. The cup of any of claims 13-16, wherein the cup includes a size and shape configured for a stacked arrangement with one or more additional cups of different volumes.

18. The cup of any of claims 13-17, wherein a bottom interior surface portion of each cup includes a plurality of equally spaced raised portions.

19. The cup of any of claim 13-18, wherein the NFC device is at least one and any of:
water resistant;
clear or with printable back;
encoded uniquely to each cup;
is readable via a mobile smart device (e.g., smartphone);
includes a QR code printed thereon; and
an alphanumeric short-code printed thereon.

20. The cup of any of claims 9-15, wherein each cup includes a stamped or printed ID number.

21. A cup return reward method comprising:
earning a plurality of reuse points to a user upon the user returning one or more cups to one or more designated bins; and
redeeming the reuse points for at least one of cash, credit, and one or more products/services with one or more sponsors or designated companies.

22. The method of claim 21, wherein the cup comprises that of any of claims 13-20.

23. The method of claim 21 or 22, wherein the designated bin comprise any of the bins of claims 15-19.

24. The method of any of claims 21-23, further comprising, washing the returned cups via a washing apparatus included in the one or more designated bins and/or a portable reusing system.

25. The method of claim 24, wherein the portable reusing system comprises the portable reusing system of claim 20.

26. The method of any of claims 21-25, wherein one or more processes associated with at least one of reusing one or more cups can be tracked by the user.

27. The method of claim 26, wherein the one or more processes are tracked by the user via an API, which can comprise an application operated from a mobile device.

28. The method of claim 26 or 27, wherein the one or more processes are selected from the group consisting of:
tracking reuse points;
redeeming reuse points;
tracking one or more processes directly associated with reusing one or more cups returned by the user, such one or more processes directly associated with reusing comprising returning, washing, rinsing, drying, and returning to service, of the one or more cups returned by the user;
and
the user's account transaction, balance and/or history.

29. The method of claim 27 or 28, wherein the API is additionally configured to track one or more, and preferably a plurality of, any physical touchpoints related to the user reusing cups including collection, washing, and redistribution.

30. The method of any of claims 27-29, wherein the API includes enabling access to a marketplace for company and/or sponsor offers, so that the user can redeem points for such offers.

31. The method of any of claims 27-30, wherein a QR code included with each cup is scanned via a camera on the user's mobile smart device resulting in the launching of a unique webpage within the user's browser application on the mobile smart device.

32. The method of claim 31, wherein:
the user inputs a phone number and/or email address to claim at least one recycled cup;
and/or
an SMS message is sent to the user which includes a link which directs the user to a GUI or webpage for completing a user profile.

33. The method of any of claims 21-32, wherein the user sends a text message to a predetermined number of an entity managing the awarding of points and redemption thereof, the text message including a number or code for a particular cup for reusing.

34. The method of claim 33, wherein in response to the text message, the entity replies with a link to complete an account setup for the user.

35. The method of any of claims 21-34, wherein a value associated with the at least one cup is retained unless and until it is returned, even, optionally, after the cup has been scanned/red by a smart bin.

36. The method of any of claims 21-35, wherein redeemed value corresponding to the number of points earned is different depending upon what the redeemed value is for (e.g., product, service, cash).

37. A reuse reward system comprising at least one server and/or processor having at least one of an application program and computer instructions operating thereon which are configured to cause the at least one server and/or processor to perform the methods according to any of claims 21-36.

38. A non-transitory, computer readable medium having at least one of an application program and computer instructions operating thereon which are configured to cause at least one server and/or at least one processor to perform the methods according to any of claims 21-36.
